(19) United States
(12) Patent Application Publication
(10) Pub. No.: US 2009/0224871 A1
(43) Pub. Date: Sep. 10, 2009

(54) METHOD FOR IDENTIFYING OPERATING AUTHORITY OF WORKERS

(75) Inventors: JHY-HAU CHIU, Tu-Cheng (TW); FEI-HSU CHEN, Tu-Cheng (TW); CHING-CHENG YANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: FOXNUM TECHNOLOGY CO., LTD., Tucheng City (TW)

(21) Appl. No.: 12/116,211

(22) Filed: May 7, 2008

(30) Foreign Application Priority Data
Mar. 7, 2008 (CN) 200810300488.4

(51) Int. Cl. G06F 7/04

(52) U.S. Cl. 340/5.2

(57) ABSTRACT

A method for identifying operating authority of a worker comprising: electronically connecting an interrogator to a controller; providing a transponder in the possession of worker with data of operating authority stored in the transponder; the interrogator reading the data in the transponder and delivering the data to the controller. The controller determines a level of operating authority of the worker according to the data. The controller allowing access only to operating functions associated with the determined level of operating authority.

### BACKGROUND

1. Field of the Invention

The invention generally relates to an identifying method, and particularly to a method for identifying operating authority of a worker.

2. Description of Related Art

In a metal manufacturing factory, there are many operation workers, program writers and maintenance workers. Because of operating safety and/or security each kind of workers may have different operating authority of a controller of a machine tool.

What is needed, therefore, is a method for identifying operating authority of a worker.

### SUMMARY

A method for identifying operating authority of a worker comprising: electronically connecting an interrogator to a controller; providing a transponder in the possession of worker with data of operating authority stored in the transponder; the interrogator reading the data in the transponder and delivering the data to the controller. The controller determines a level of operating authority of the worker according to the data. The controller allowing access only to operating functions associated with the determined level of operating authority.

Other advantages and novel features will become more apparent from the following detailed description of preferred embodiment when taken in conjunction with the accompanying drawings.

### BRIEF DESCRIPTION OF THE DRAWINGS

FIG. 1 is a flow chart of a method for identifying operating authority of a worker in accordance with an embodiment of the present invention.

FIG. 2 is a diagram of an identifying system in accordance with an embodiment of the present invention.

### DETAILED DESCRIPTION OF THE EMBODIMENT

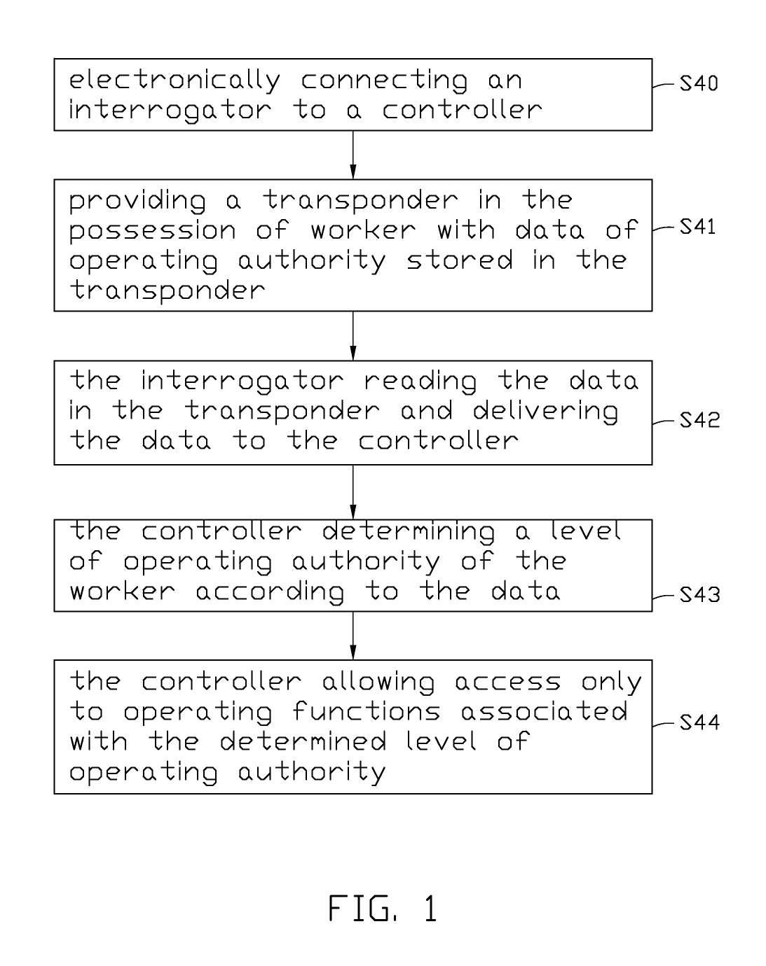

Referring to FIG. 1, a method for identifying operating authority of a worker in accordance with an exemplary embodiment is provided. The method includes the following steps.

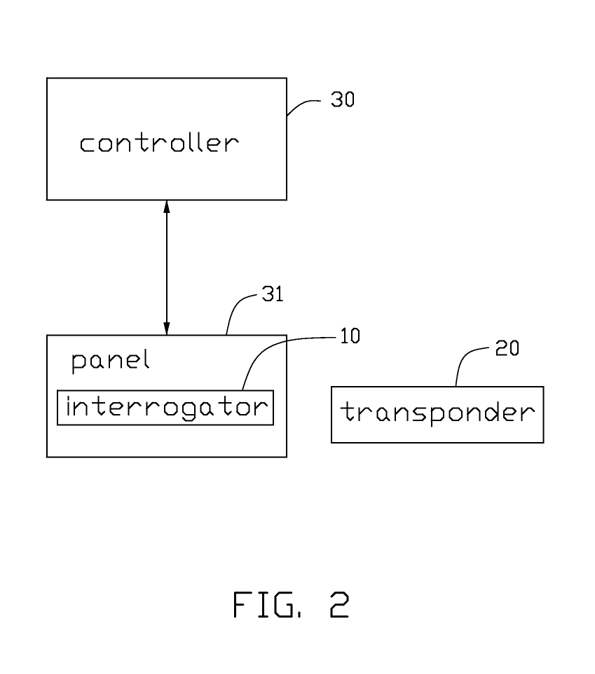

Step S40: referring to FIG. 2, an interrogator 10 is electronically connected to a controller 30. The interrogator 10 is mounted on a panel 31 of the controller 30.

Step S41: a transponder 20 is provided and operating authority data is stored in the transponder 20. The operating authority data includes personal data and a level of operating authority of a worker in possession of the transponder 20. The level of operating authority of a worker may be defined according to their job, such as operation worker, program writer or maintenance worker.

Step S42: the interrogator 10 reads the data in the transponder 20 and delivers the data to the controller 30. When a worker with the transponder 20 is present within a predetermined range of the interrogator 10, the interrogator 10 reads the personal data and the level of operating authority of the transponder 20 and delivers the data to the controller 30.

Step S43: the controller 30 determines the level of operating authority of the worker according to the data of operating authority of the transponder 20.

Step S44: the controller 30 provides access to operating functions to the worker associated with their level of operating authority.

In this embodiment, the interrogator 10 uses radio frequency identification technology to read the operating authority data of the transponder 20. Communications between the interrogator 10 and the transponder 20 may be accomplished by any other conventional means known in the art.

Finally, it is to be understood that the above-described embodiment are intended to illustrate rather than limit the invention. Variations may be made to the embodiment without departing from the spirit of the invention as claimed. The above-described embodiment illustrate the scope of the invention but do not restrict the scope of the invention.

What is claimed is:

1. A method for identifying operating authority of a worker, the method comprising:
electronically connecting an interrogator to a controller;
providing a transponder in the possession of worker with data of operating authority stored in the transponder;
the interrogator reading the data in the transponder and delivering the data to the controller;
the controller determining a level of operating authority of the worker according to the data; and
the controller allowing access only to operating functions associated with the determined level of operating authority.

2. The method as claimed in claim 1, wherein communications between the interrogator and the transponder use radio frequency identification technology.

3. The method as claimed in claim 1, wherein the interrogator is mounted on a panel of the controller.

4. The method as claimed in claim 1, wherein the data includes personal data and a level of operating authority of a worker in possession of the transponder.
